(19) United States
(12) Patent Application Publication
(10) Pub. No.: US 2026/0302681 A1
(43) Pub. Date: Oct. 1, 2026

(54) CONNECTOR

(71) Applicant: SUMITOMO WIRING SYSTEMS, LTD., Mie (JP)

(72) Inventor: Naoyuki UOMI, Mie (JP)

(21) Appl. No.: 19/629,334

(22) Filed: Mar. 26, 2026

(30) Foreign Application Priority Data
Mar. 31, 2025 (JP) 2025-058811

(51) Int. Cl. H01R 13/508; H01R 13/52

(52) U.S. Cl. CPC H01R 13/508; H01R 13/5202

(57) ABSTRACT

A connector according to the present disclosure is a connector capable of being fitted to a counterpart connector in a first direction, including: a first connector housing; a second connector housing capable of accommodating the first connector housing; and a retainer configured to be attached to extend in the first connector housing and the second connector housing, wherein the retainer is configured to be attachable to the first connector housing and the second connector housing from a second direction that is orthogonal to the first direction in an accommodated state in which the first connector housing is accommodated in the second connector housing, and the retainer holds the first connector housing in the accommodated state.

### CROSS-REFERENCE TO RELATED APPLICATIONS

This application is based on and claims priority from Japanese Patent Application No. 2025-058811, filed on Mar. 31, 2025, with the Japan Patent Office, the disclosure of which is incorporated herein in its entirety by reference.

### TECHNICAL FIELD

The present disclosure relates to a connector.

### BACKGROUND

The connector described in JP 2018-085287 A is known as a conventional connector including a retainer. The connector is configured such that a projection of a back retainer is locked to a through hole of a tube portion of a housing to prevent detachment of the back retainer, thus preventing detachment of a second O-ring.

### SUMMARY

For the above-described connector, the retainer only needs to have a holding force sufficient to press the second O-ring. However, the locking force between the projection and the through hole is not sufficient to cause the retainer to have a function of holding the connector. On the other hand, using a bolt in place of the retainer causes an increase in costs, and therefore is not expedient.

A connector according to the present disclosure is a connector capable of being fitted to a counterpart connector in a first direction, including: a first connector housing; a second connector housing capable of accommodating the first connector housing; and a retainer configured to be attached to extend in the first connector housing and the second connector housing, wherein the retainer is configured to be attachable to the first connector housing and the second connector housing from a second direction that is orthogonal to the first direction in an accommodated state in which the first connector housing is accommodated in the second connector housing, and the retainer holds the first connector housing in the accommodated state.

According to the present disclosure, it is possible to provide a connector including a retainer with a high holding force.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view showing a connector according to an embodiment.

FIG. 2 is an exploded perspective view showing the connector according to an embodiment.

FIG. 3 is a front view of the connector according to an embodiment.

FIG. 4 is a right side view of the connector according to an embodiment.

FIG. 5 is a cross-sectional view taken along the line A-A in FIG. 3.

FIG. 6 is a cross-sectional view taken along the line B-B in FIG. 4.

FIGS. 7A and 7B are enlarged cross-sectional views of principal parts respectively showing states before and after attaching a retainer during a retainer attachment process in the cross-sectional view taken along the line B-B in FIG. 4.

FIG. 8 is a perspective view showing the retainer of the connector according to an embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, aspects of the present disclosure will be listed and described.
[1] A connector according to the present disclosure is a connector capable of being fitted to a counterpart connector in a first direction, including: a first connector housing; a second connector housing capable of accommodating the first connector housing; and a retainer configured to be attached to extend in the first connector housing and the second connector housing, wherein the retainer is configured to be attachable to the first connector housing and the second connector housing from a second direction that is orthogonal to the first direction in an accommodated state in which the first connector housing is accommodated in the second connector housing, and the retainer holds the first connector housing in the accommodated state.

With such a configuration, in the accommodated state in which the first connector housing is accommodated in the second connector housing, the retainer is attached to extend in the first connector housing and the second connector housing from the second direction. Accordingly, the first connector housing can be held in the accommodated state by the overall strength of the retainer. Therefore, even when the retainer is made of resin, for example, the retainer can sufficiently perform the function of holding the connector. In addition, the total weight of the body of the connector can be reduced as compared with a case where, for example, a bolt is used in place of the retainer, thus making it possible to further reduce material costs.
[2] In the connector according to [1] above, it is preferable that the retainer is disposed so as to penetrate the second connector housing in the second direction in the accommodated state.

With such a configuration, a portion in which the retainer is to be disposed is provided inside the second connector housing. Accordingly, the retainer comes into contact with the interior of the second connector housing, thus increasing the locking force between the second connector housing and the retainer.
[3] In the connector according to [1] or [2] above, it is preferable that the retainer includes a lock portion configured to be locked to the first connector housing in the second direction in the accommodated state, thereby preventing dislodgement of the retainer.

With such a configuration, once the retainer has been attached to the connector, the first connector housing and the lock portion are in the locked state, and it is thus possible to make the retainer less likely to be dislodged from the first connector housing.
[4] In the connector according to any one of [1] to [3] above, it is preferable that the retainer includes a rotation prevention portion configured to prevent rotation of the lock portion in the accommodated state.

With such a configuration, the first connector housing and the lock portion are positioned relative to each other in the rotation direction when the retainer is attached to the connector, thus making it possible to more reliably achieve locking between the first connector housing and the lock portion.

### Details of Embodiments of the Present Disclosure

Specific examples of embodiments of the connector according to the present disclosure will be described below with reference to the drawings. In the drawings, portions of configurations may be shown exaggerated or simplified for convenience of description. In addition, dimensional proportions of the portions may differ between the drawings. The term “orthogonal” or “parallel” as used herein includes not only being exactly orthogonal or parallel, but also being substantially orthogonal or parallel, as long as the operations and effects of the present embodiment can be achieved. The term “tubular” as described herein includes not only a shape with a peripheral wall continuously formed around the entire circumference in a circumferential direction, but also a tubular shape formed by a combination of a plurality of components, and a tubular shape having a cutout or the like in a circumferential portion thereof, such as a C-shape or a U-shape. Note that the “tubular” shape includes, but is not limited to, a circular shape, an elliptic shape, and a polygonal shape having a pointed or round angle. The term “opposing” as used herein means that surfaces or members are located in front of each other, and includes not only a case where they are located fully in front of each other, but also a case where they are located partially in front of each other. The term “opposing” as used herein includes not only a case where two members are away from each other, but also a case where two members are in contact with each other. The terms “first”, “second”, “third”, and the like are used to simply differentiate between objects, and not to be construed as ranking objects. It should be noted that the present invention is not limited to these examples, and is intended to include all modifications which fall within the scope of the claims and the meaning and scope of equivalents thereof.

### Embodiment

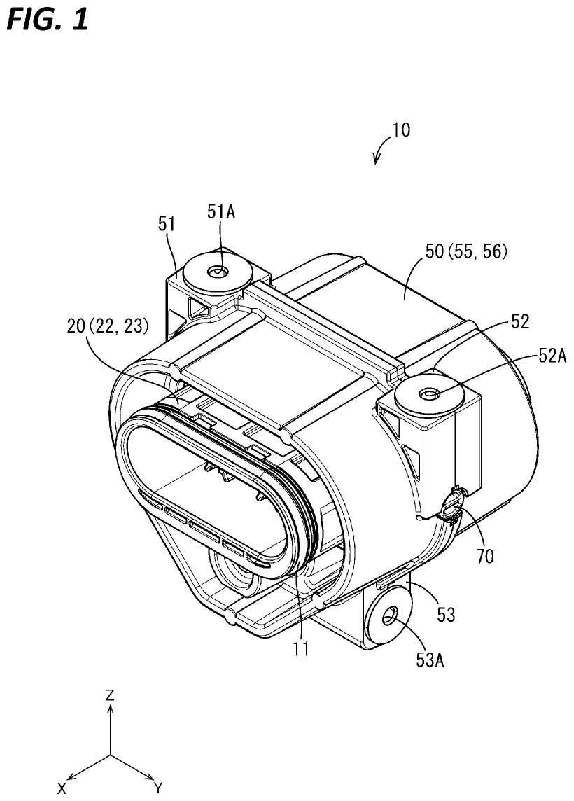

An embodiment of the present disclosure will be described with reference to FIGS. 1 to 8. In the following description, an X-axis direction is the front-rear direction, a Y-axis direction is the left-right direction, and a Z-axis direction is the up-down direction. The description will be given assuming that, in the drawings, the direction indicated by an arrow X is the forward direction, the direction indicated by an arrow Y is the rightward direction, and the direction indicated by an arrow Z is the upward direction.

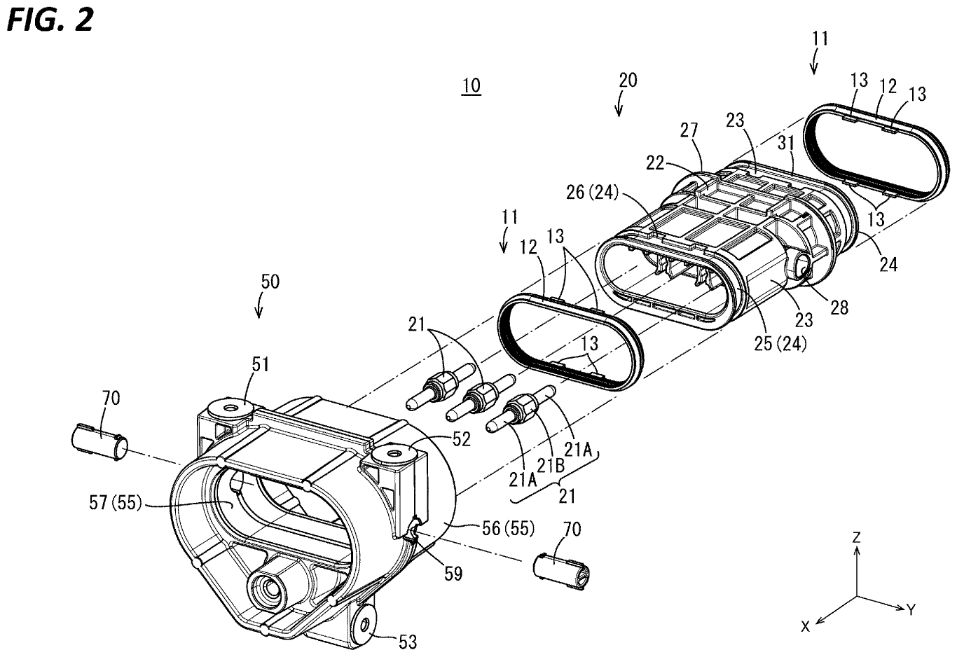

Note that, in the present embodiment, the X-axis direction (front-rear direction) illustrated in FIG. 2 corresponds to a first direction according to the present disclosure, and the Y-axis direction (left-right direction) illustrated in FIG. 2 corresponds to a second direction according to the present disclosure. In addition, the directions in the drawings need not necessarily represent orientations of a connector 10 and a counterpart connector during use. Furthermore, for a plurality of identical members, reference numerals may be assigned to some of the members, and reference numerals may be omitted for the other members.

### (Overall Configuration of Connector 10)

As shown in FIG. 1, a connector 10 is configured to be fittable to a counterpart connector (not shown) in the front-rear direction. As shown in FIGS. 1 and 2, the connector 10 mainly includes an inner housing 20 that accommodates male terminals 21 serving as terminal fittings, and an outer housing 50 formed to be capable of accommodating the inner housing 20.

### (Configuration of Connector 10)

As shown in FIG. 2, the connector 10 (see FIG. 1) includes a plurality of male terminals 21, the inner housing 20, the outer housing 50, a pair of rubber rings 11, and a pair of retainers 70. The connector 10 according to the present embodiment includes three male terminals 21. Note that a first connector housing of the present disclosure corresponds to the inner housing 20, and a second connector housing of the present disclosure corresponds to the outer housing 50.

### (Configuration of Male Terminal 21)

As shown in FIGS. 2, 3, and 5, the three male terminals 21 are arranged in the left-right direction. In the present embodiment, the three male terminals 21 have substantially the same shape, and therefore one male terminal 21 will be described as a representative example. The male terminal 21 includes an inter-mediate portion 21B held by the inner housing 20, and a pair of connection portions 21A extending toward the front and rear sides from the intermediate portion 21B.

The male terminal 21 is made of metal. As the material of the male terminal 21, it is possible to use, for example, a conductive metal material such as copper, a copper alloy, aluminum, and an aluminum alloy. The male terminal 21 can be formed, for example, by cutting a metal plate having excellent conductivity.

The male terminal 21 is a unitary component formed by integrating the intermediate portion 21B and the pair of connection portions 21A into a single piece so as to be linearly continuous as a whole in the front-rear direction. Each of the connection portion 21A is formed in a columnar shape with a rounded tip. The male terminal 21 is connected to a female terminal (not shown) when the counterpart connector (not shown) and the connector 10 are fitted to each other at the connection portions 21A. Thus, the counterpart connector (not shown) and the connector 10 are electrically connected to each other.

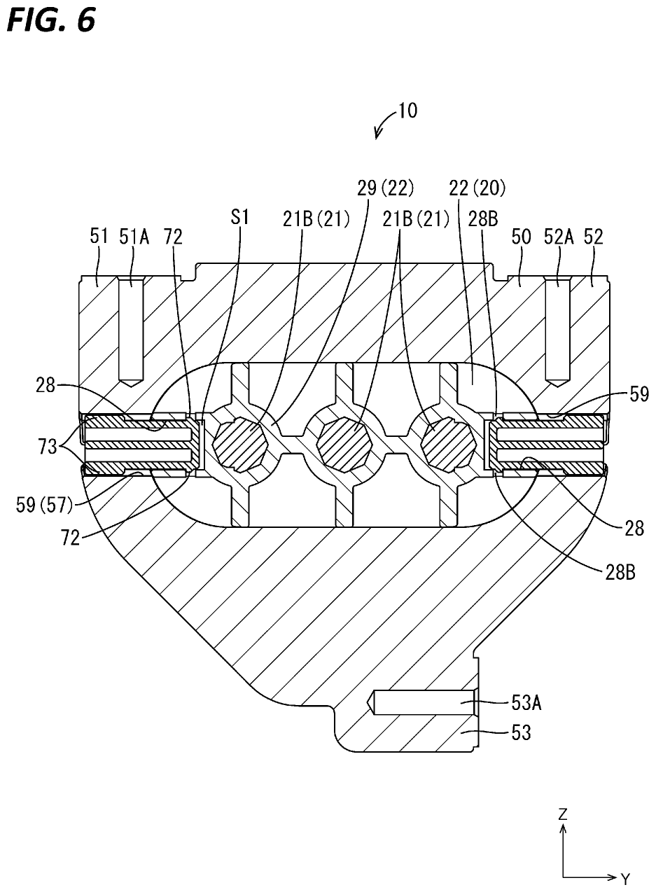

As shown in FIGS. 2 and 6, the intermediate portion 21B is formed to have a substantially octagonal cross section as viewed in the X-axis direction. The intermediate portion 21B is held by a terminal holding portion 29 of the inner housing 20 through insert molding or press fitting.

### (Inner Housing 20)

As shown in FIG. 1, the inner housing 20 is mounted to the outer housing 50 from the rear side and accommodated therein. The inner housing 20 is made of synthetic resin, for example. As shown in FIGS. 1 and 2, the inner housing 20 includes a substantially tubular inner housing body portion 22 that holds the plurality of male terminals 21 and is open in the front-rear direction.

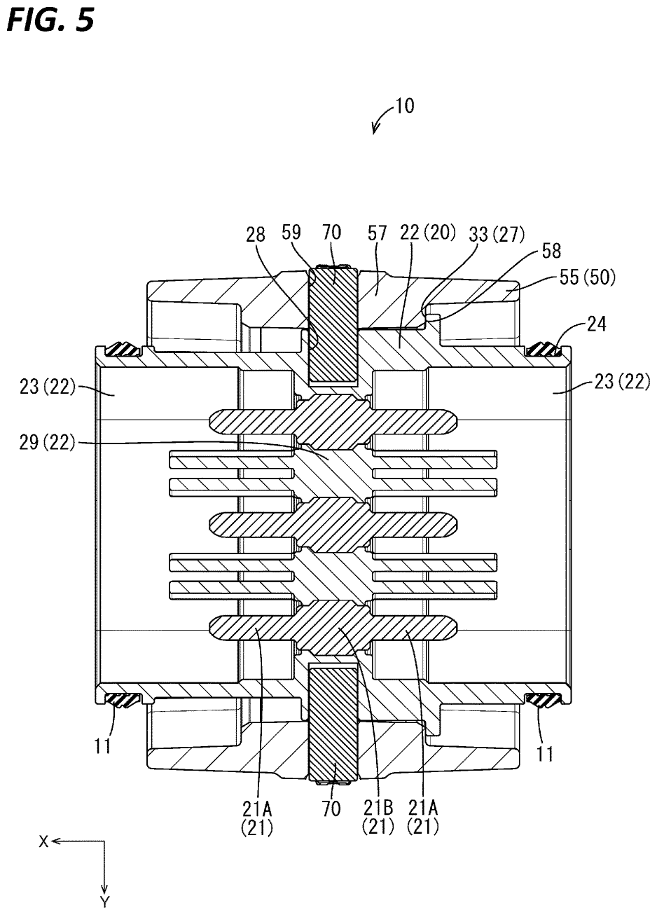

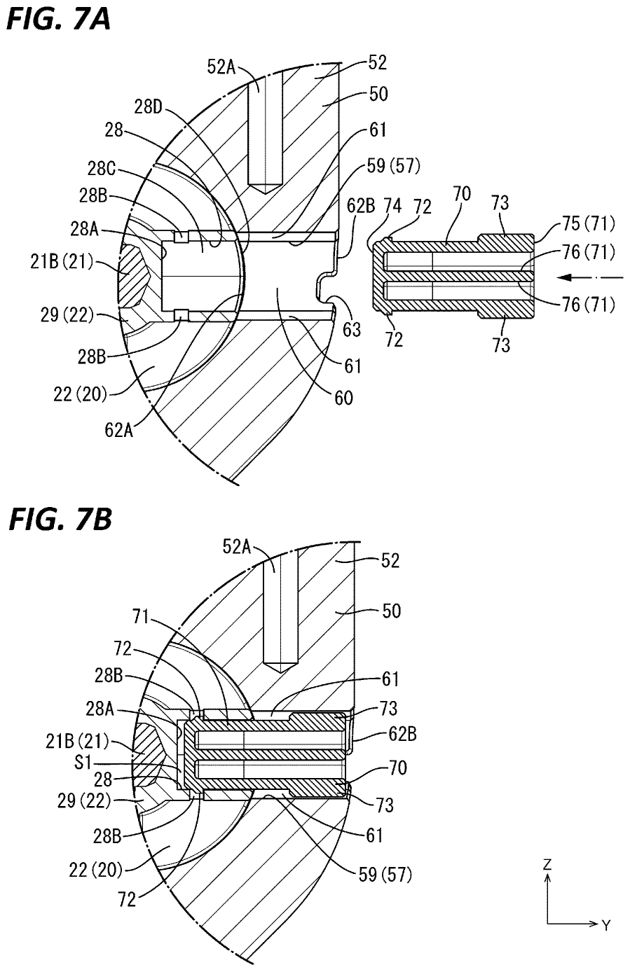

As shown in FIGS. 2 and 5, the inner housing body portion 22 includes a pair of hood portions 23 disposed in the front-rear direction, a pair of rubber ring attachment grooves 24 provided at the respective ends of the two hood portions 23 on the open side, a flange portion 27 disposed between the two hood portions 23, and a pair of retainer first attachment holes 28 (see FIG. 7A) disposed forward of the flange portion 27.

As shown in FIG. 2, the counterpart connector (not shown) can be fitted into each of the two hood portions 23 from opposite sides in the front-rear direction. As shown in FIG. 5, the pair of hood portions 23 are disposed at positions to cover the pair of front and rear connection portions 21A of each of the plurality of male terminals 21. As shown in FIGS. 5 and 6, the inner housing body portion 22 holds the intermediate portion 21B of each of the plurality of male terminals 21 that are disposed to penetrate therethrough in the front-rear direction.

As shown in FIG. 2, the rubber ring attachment grooves 24 are formed around the outer circumferences of the corresponding hood portions 23. Each of the rubber ring attachment grooves 24 includes an attachment body groove 25 capable of accommodating a rubber ring body portion 12 described below, and a pair of receiving portions 26 that are disposed on the upper and lower sides of the attachment body groove 25 and are capable of accommodating the corresponding protruding portions 13 described below. The receiving portions 26 are grooves extending toward the inner housing body portion 22 from the corresponding attachment body groove 25. In a state in which each of the rubber rings 11 is attached to the corresponding rubber ring attachment groove 24, the rubber ring body portion 12 is accommodated in the attachment body groove 25, and the protruding portions 13 are accommodated in the corresponding receiving portions 26.

As shown in FIGS. 2 and 5, the flange portion 27 radially protrudes from the outer circumference of the inner housing body portion 22. The flange portion 27 has a predetermined thickness in the front-rear direction. The flange portion 27 has an abutting surface 33 capable of abutting against an abutment surface 58, which will be described below, of the outer housing 50. The abutting surface 33 is a forward facing surface constituting a part of the outer surface of the flange portion 27. The abutting surface 33 and the abutment surface 58 are provided for stopping the inner housing 20 at a front end thereof when the inner housing 20 is mounted to the outer housing 50.

In FIG. 5, the abutting surface 33 abuts against the abutment surface 58 when the housings 20 and 50 of the connector 10 are mounted to each other, and thereby the inner housing 20 is mounted to the outer housing 50 at a predetermined position. Thus, the abutting surface 33 and the abutment surface 58 have a function of positioning the housings 20 and 50 relative to each other in the front-rear direction.

As shown in FIGS. 5, 6, 7A, and 7B, terminal holding portions 29 capable of respectively holding the three intermediate portions 21B while covering the entire circumferences thereof are formed inside the inner housing body portion 22.

As shown in FIGS. 6, 7A, and 7B, the inner housing body portion 22 includes a pair of retainer first attachment holes 28 that are open in the left-right direction. In the present embodiment, the pair of retainer first attachment holes 28 have substantially the same shape, and therefore one retainer first attachment hole 28 will be described as a representative example.

As shown in FIG. 7A, the retainer first attachment hole 28 is an internal space of a cylindrical member in which a portion of the corresponding retainer 70 is accommodated in the attachment direction. A side surface opposing wall 28A that is continuous with the corresponding terminal holding portion 29, a pair of upper and lower lock holes 28B, and an opening 28D that is open outward in the attachment direction are formed on a peripheral wall 28C constituting the retainer first attachment hole 28. In the opening 28D, the internal space of each of the two retainer first attachment holes 28 is in communication with the internal space of the corresponding retainer second attachment hole 59 described below.

Half of the entire length of the corresponding retainer 70 is accommodated in the retainer first attachment hole 28. The radial dimension of the internal space of the retainer first attachment hole 28 is set to a dimension slightly larger than the radial dimension of the retainer 70. The radial dimension of the internal space of the retainer first attachment hole 28 and the radial dimension of the internal space of the retainer second attachment hole 59 are set to be substantially the same.

### (Rubber Ring 11)

As shown in FIGS. 1 and 2, the connector 10 includes the pair of rubber rings 11 that are mounted to the pair of rubber ring attachment grooves 24. The rubber rings 11 each have elasticity. The rubber rings 11 each have a circular ring shape that is elongated in the left-right direction. The rubber rings 11 provide a seal between the inner housing 20 and the counterpart housing.

The rubber rings 11 is configured to be elastically deformable. As shown in FIG. 2, each of the rubber rings 11 includes, for example, a rubber ring body portion 12, and a plurality of (four in the present embodiment) protruding portions 13 protruding from the rubber ring body portion 12. The rubber ring body portion 12 is formed in, for example, a circular ring shape that is continuous so as to be attachable to the rubber ring attachment groove 24 over the entire circumference thereof. In other words, each of the rubber rings 11 of the present embodiment is formed in an oval shape that is elongated in the left-right direction. The protruding portions 13 protrude in the front-rear direction from a circumferential portion of the rubber ring body portion 12, for example. The plurality of protruding portions 13 are arranged in the left-right direction, for example. As a result of the protruding portions 13 being accommodated in the receiving portions 26, the rubber rings 11 are prevented from rotating.

The rubber rings 11 are each made of rubber, for example. As the material of the rubber rings 11, it is possible to use, for example, nitrile rubber, silicone rubber, urethane rubber, acrylic rubber, butyl rubber, ethylene-propylene rubber, or the like.

### (Outer Housing 50)

As shown in FIGS. 1 to 4, the outer housing 50 includes an outer housing body portion 55. For example, the outer housing body portion 55 includes an outer hood portion 56 that covers the outer circumference of the inner housing body portion 22, and fixing portions 51, 52, and 53 that are formed as a single piece with the outer hood portion 56. As the material of the outer housing 50, it is possible to use, for example, a metal material such as copper or a copper alloy, aluminum or an aluminum alloy, stainless steel, or the like.

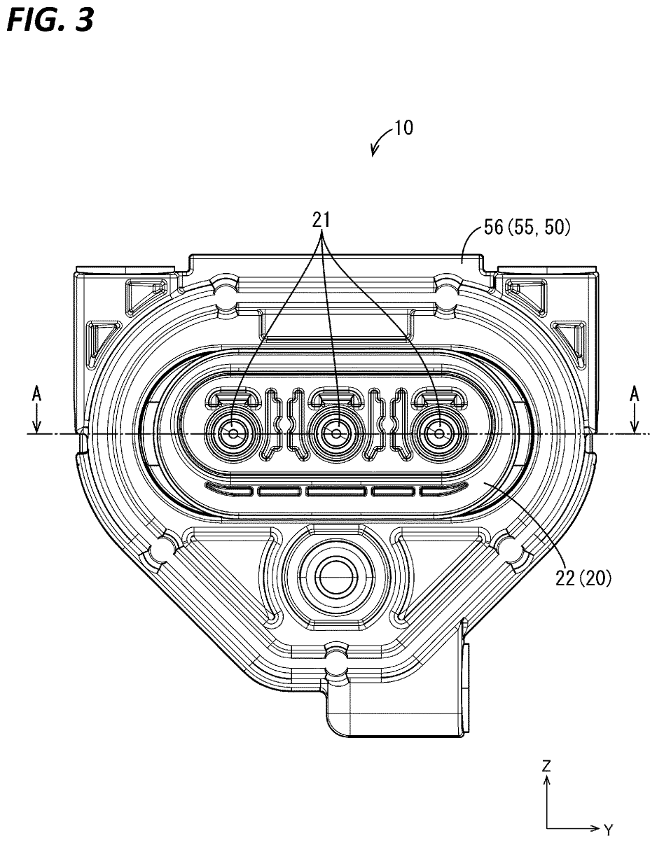

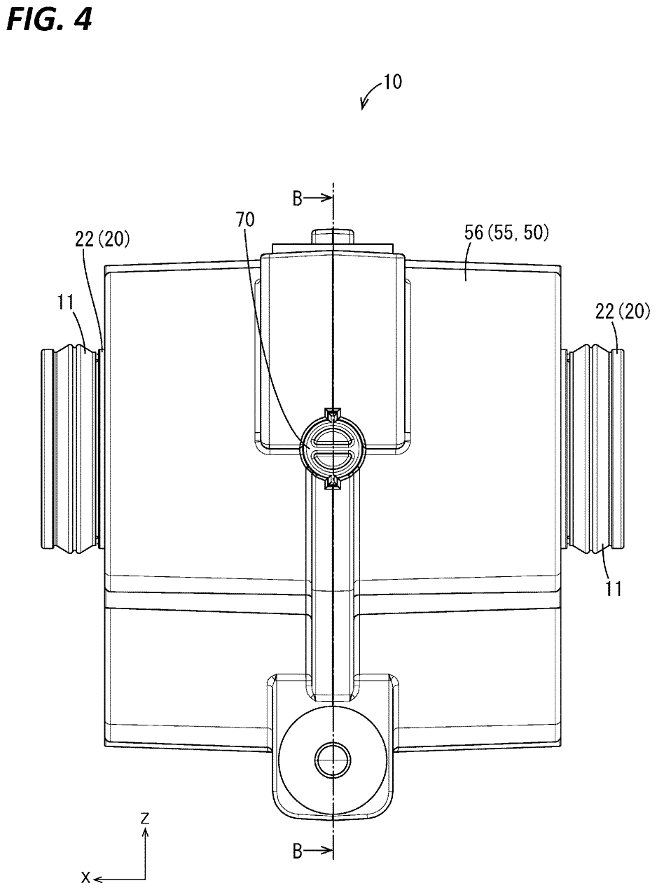

As shown in FIGS. 3 and 4, the outer hood portion 56 is formed, for example, to partially surround the outer circumference of the inner housing body portion 22. The outer housing body portion 55 includes an accommodating portion 57 (see FIG. 2) that partially accommodates the outer side of the inner housing 20. The accommodating portion 57 is formed to extend on the front and rear sides of the outer hood portion 56, and is formed in, for example, a ring shape including an inner circumferential surface having a shape corresponding to the shape of the outer circumferential surface of the inner housing body portion 22. As shown in FIG. 5, an abutment surface 58 that abuts against the abutting surface 33 of the flange portion 27 is formed at a rear end of the accommodating portion 57.

As shown in FIGS. 1, 6, 7A, and 7B, the accommodating portion 57 includes a pair of retainer second attachment holes 59 extending therethrough in the left-right direction. Each of the retainer second attachment holes 59 includes a portion in which the remaining half of the entire length of the retainer 70 is disposed. That is, each of the retainers 70 is accommodated in its entirety by the corresponding retainer first attachment hole 28 and the corresponding retainer second attachment hole 59. The corresponding retainer attachment holes 28 and 59 are in communication with each other. Accordingly, the retainers 70 are brought into contact, although with half the length thereof, with the interior of the second connector housing 50, thus making it possible to increase the locking force between the second connector housing 50 and the retainers 70.

The outer housing 50 of the present embodiment has an inverted triangular outer shape as viewed from the front. In the present embodiment, the pair of retainer second attachment holes 59 have substantially the same shape, and therefore one retainer second attachment hole 59 will be described as a representative example.

As shown in FIG. 1, the fixing portions 51, 52, and 53 are portions that are fastened to a counterpart device (not shown) in the up-down direction or the left-right direction using bolts. A first fixing portion 51 and a second fixing portion 52 are provided at upper portions of the outer housing 50, and a third fixing portion 53 is provided at a lower portion of the outer housing 50. The fixing portions 51 and 52 respectively include paired insertion holes 51A and 52A, each of which is a hole through which a bolt can be passed in the up-down direction. The third fixing portion 53 includes a third insertion hole 53A, which is a hole through which a bolt can be passed in the left-right direction.

As shown in FIG. 7A, the internal space of the retainer second attachment hole 59 is formed in communication with the internal space of the corresponding retainer first attachment hole 28 on the front side in the attachment direction. Thus, a front portion of the retainer 70 in the attachment direction is accommodated in the retainer first attachment hole 28, and a rear portion of the retainer 70 in the attachment direction is attached to the retainer second attachment hole 59. In this manner, the retainer 70 is attached across the retainer first attachment hole 28 and the retainer second attachment hole 59 so as to form a latch or a wedge.

As shown in FIG. 7A, the retainer second attachment hole 59 is an accommodation hole in which the body of the retainer 70 is accommodated from the center to the distal end thereof in the attachment direction. The retainer second attachment hole 59 is an accommodation hole extending through the outer housing body portion 55 in the left-right direction that is orthogonal to the fitting direction. The radial dimension of the internal space of the retainer second attachment hole 59 is set to a dimension slightly larger than the radial dimension of the retainer 70.

A peripheral wall 60 constituting the retainer second attachment hole 59 has formed thereon a pair of guide grooves 61 in which a pair of rotation prevention portions 73 described below are to be accommodated, an attachment port 62A that is open forward in the attachment direction, an attachment port 62B that is open rearward in the attachment direction, and a cut-out portion 63 formed by cutting out a part of the peripheral wall from the attachment port 62B.

### (Retainer 70)

As shown in FIG. 2, each of the retainers 70 is attached to extend in the inner housing 20 and the outer housing 50. The retainers 70 are made of synthetic resin, for example. The retainers 70 can hold the inner housing 20 to the outer housing 50 by the overall strength of the retainers 70.

In an accommodated state in which the inner housing 20 is accommodated in the outer housing 50, it is possible to restrict relative movement between the housings 20 and 50 by the overall strength of the retainers 70. The retainers 70 are each formed in an overall substantially columnar shape, for example.

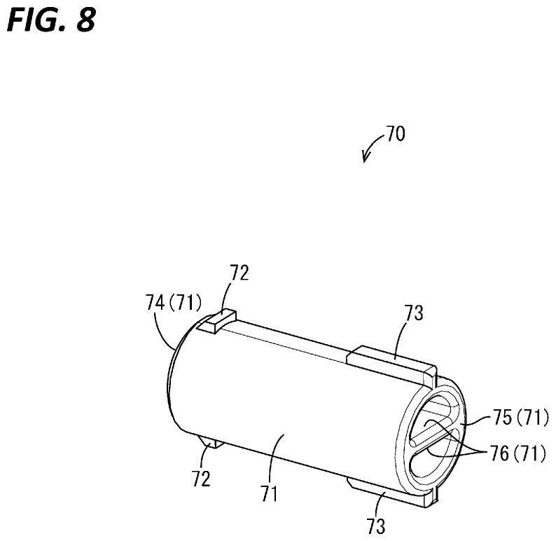

As shown in FIGS. 7A, 7B, and 8, each of the retainers 70 includes a retainer body portion 71 including a columnar peripheral wall, a pair of lock portions 72 protruding radially outward from one end of the retainer body portion 71, and a pair of rotation prevention portions 73 protruding radially outward from the other end of the retainer body portion 71. The rotation prevention portions 73 are disposed substantially collinear with the corresponding lock portions 72. In the present embodiment, the pair of lock portions 72 have substantially the same shape, and therefore one lock portion 72 will be described as a representative example. In the present embodiment, the pair of rotation prevention portions 73 have substantially the same shape, and therefore one rotation prevention portion 73 will be described as a representative example.

The retainer body portion 71 includes a front surface 74, which is a forward surface in the attachment direction in which the retainer 70 is attached to the inner housing 20, a rear surface 75, which is a rearward surface in the attachment direction, and an interior partitioning wall 76 that divides the interior into two parts in the up-down direction. As shown in FIGS. 6, 7A, and 7B, the upper and lower sides of the interior partitioning wall 76 of the retainer body portion 71 are thinned so as to be open from the front surface 74 side toward the rear surface 75 side.

As shown in FIGS. 6, 7A, 7B, and 8, the two lock portions 72 protrude upward and downward, respectively, of the retainer body portion 71. The lock portions 72 are provided at positions near the front surface 74 of the retainer body portion 71. The two lock portions 72 are configured to be locked to the corresponding lock holes 28B. The rotation prevention portions 73 are provided on the rear surface 75 side of the retainer body portion 71. The two rotation prevention portions 73 are configured to be accommodated in the corresponding guide grooves 61. When the retainers 70 are to rotate, the rotation prevention portions 73 abut against the walls of the guide grooves 61, thus preventing rotation of the retainers 70. In addition, the rotation prevention portions 73 are moved along the guide grooves 61, thus guiding movement for accommodating the retainers 70 in the attachment holes 28 and 59.

### (Operations of the Present Embodiment)

### Method for Assembling Connector

The present embodiment is configured as described above, and operations thereof will be described next. An example of the assembly method of the connector 10 will be described.

As shown in FIG. 2, first, the three male terminals 21 are attached to the inner housing body portion 22. Thus, the intermediate portion 21B of each of the male terminals 21 is held by the corresponding terminal holding portion 29.

Next, the inner housing 20 is accommodated in the outer housing 50. The abutting surface 33 and the abutment surface 58 abut against each other, and thereby the inner housing 20 is accommodated in the accommodating portion 57 while being positioned relative to the outer housing 50.

As shown in FIG. 7A, at this time, the retainer first attachment holes 28 and the corresponding retainer second attachment holes 59 are in communication with each other in the internal space. More specifically, the openings 28D of the retainer first attachment holes 28 and the attachment ports 62A of the corresponding retainer second attachment holes 59 are connected to each other.

Subsequently, in the accommodated state in which the inner housing 20 is accommodated in the outer housing 50, the pair of retainers 70 are attached to extend in the inner housing 20 and the outer housing 50 in the left-right direction that is orthogonal to the fitting direction.

More specifically, each of the retainers 70 enters the corresponding retainer second attachment hole 59 from the corresponding attachment port 62B. Thereafter, the retainer body portion 71 enters the retainer first attachment hole 28, and the lock portions 72 are accommodated in the lock holes 28B through the guide grooves 61. Accordingly, the retainer body portion 71 of the retainer 70 is attached across the retainer first attachment hole 28 and the retainer second attachment hole 59 (FIG. 7B). When the inner housing 20 and the outer housing 50 are to move relative to each other in the front-rear direction, shearing force will act on the retainer 70. However, the retainer 70 will not be sheared, and the inner housing 20 and the outer housing 50 are held in a firmly coupled state.

At this time, the lock portions 72 are fitted in and locked to the corresponding lock holes 28B on the front side in the attachment direction. Thus, the movement of the retainer 70 in the left-right direction is locked. In addition, the rotation prevention portions 73 are fitted into the corresponding guide grooves 61 and held so as to be able to abut thereagainst in the rotation direction. Thus, the retainer 70 is prevented from rotating. Here, when at least either the lock portions 72 or the rotation prevention portions 73 pass through the guide grooves 61 in a state in which the retainer 70 is positioned in the rotation direction by the rotation prevention portions 73, the lock portions 72 can be more reliably locked to the lock holes 28B.

Note that the retainer 70 is held to the inner housing 20 in a state in which a predetermined space S1 is provided between the front surface 74 of the retainer 70 and the side surface opposing wall 28A (FIG. 7B).

The position, the range, and the size of the lock holes 28 on the front side in the attachment direction are not limited to those described above, and the lock holes 28 need only be able to perform the function of locking the lock portions as long as the object of the present disclosure is not impaired. In addition, the position, the range, and the size of the guide grooves 61 on the rear side in the attachment direction are not limited to those described above, and the retainer 70 need only be held in abutment against the rotation prevention portions 73 as long as the object of the present disclosure is not impaired.

Then, the pair of rubber rings 11 are attached to the rubber ring attachment grooves 24 of the inner housing 20.

### (Operations and Effects of the Embodiment)

The present embodiment described thus far can achieve the following effects.
(1) The connector 10 is capable of being fitted to the counterpart connector in the first direction (front-rear direction), and includes: the first connector housing 20; the second connector housing 50 capable of accommodating the first connector housing 20; and the retainers 70 configured to be attached to extend in the first connector housing 20 and the second connector housing 50, wherein the retainers 70 are configured to be attachable to the first connector housing 20 and the second connector housing 50 from the second direction (left-right direction) that is orthogonal to the first direction (front-rear direction) in the accommodated state in which the first connector housing 20 is accommodated in the second connector housing 50, and the retainers 70 hold the first connector housing in the accommodated state.

With such a configuration, in the accommodated state in which the first connector housing 20 is accommodated in the second connector housing 50, the retainers 70 are attached to extend in the first connector housing 20 and the second connector housing 50 from the second direction (left-right direction). Accordingly, the first connector housing 20 can be held in the state of being accommodated in the second connector housing 50 by the overall strength of the retainers 70. Therefore, even when the retainers 70 are made of resin, for example, the retainers 70 can sufficiently perform the function of holding the first connector housing 20 of the connector 10 to the second connector housing 50. In addition, the total weight of the body of the connector 10 can be reduced as compared with a case where, for example, bolts are used in place of the retainers 70, thus making it possible to further reduce costs.
(2) The retainers 70 are disposed so as to penetrate the second connector housing 50 in the second direction (left-right direction) in the accommodated state.

With such a configuration, portions in which the retainers 70 are to be disposed are provided inside the second connector housing. Accordingly, the retainers 70 come into contact with the interior of the second connector housing 50 with a length up to half the length thereof, thus increasing the locking force between the second connector housing 50 and the retainers 70.
(3) The retainers 70 each include the lock portions 72 configured to be locked to the first connector housing 20 in the second direction (left-right direction) in the accommodated state, thereby preventing dislodgement of the retainers 70.

With such a configuration, once the retainers 70 have been attached to the connector 10, the first connector housing 20 and the lock portions 72 are in the locked state, and it is thus possible to make the retainers 70 less likely to be dislodged from the first connector housing 20.
(4) The retainers 70 each include the rotation prevention portions 73 configured to prevent rotation of the lock portions 72 in the accommodated state.

With such a configuration, the first connector housing 20 and the lock portions 72 are positioned relative to each other in the rotation direction when the retainers 70 are attached to the connector 10, thus making it possible to more reliably achieve locking between the first connector housing 20 and the lock portions 72.

### Other Embodiments

The above-described embodiment can be implemented with the following modifications. The above-described embodiment and the following modifications can be implemented in combination with each other as long as there are no technical discrepancies.
(1) The method for assembling the connector 10 described in the above embodiment is merely an example, and the connector 10 may be assembled using other assembly methods as long as the object of the present disclosure is not impaired.
(2) The above embodiment illustrates a configuration in which the fixing portions 51, 52, and 53 are provided. However, the number of fixing portions may be increased or decreased as long as the object of the present disclosure is not impaired.
(3) The above embodiment illustrates a configuration in which three male terminals 21 are provided. However, the number of male terminals 21 may be increased or decreased as long as the object of the present disclosure is not impaired.
(4) The above embodiment illustrates a configuration in which a pair of retainers 70 are provided. However, the number of retainers 70 may be increased or decreased as long as the object of the present disclosure is not impaired.
(5) The above embodiment illustrates a configuration in which the pair of retainers 70 are attached in the attachment direction (left-right direction) that is orthogonal to the fitting direction (front-rear direction). However, as long as the object of the present disclosure is not impaired, the retainers 70 may be attached in any attachment direction, and may be attached in the up-down direction, for example.
(6) The above embodiment illustrates a configuration in which a pair of lock portions 72 are provided. However, at least one locking structure for holding the connector may be provided as long as the object of the present disclosure is not impaired.
(7) The above embodiment illustrates a configuration in which a pair of rotation prevention portions 73 are provided. However, the number of rotation prevention portions 73 may be increased or decreased as long as the object of the present disclosure is not impaired.
(8) In the above embodiment, the shape, the size, or the attachment range of the pair of retainers 70 each including the pair of lock portions 72 and the pair of rotation prevention portions 73 is merely an example, and it is possible to adopt any shape, size, or attachment range as long as the object of the present disclosure is not impaired.
(9) The above embodiment illustrates a configuration in which the space S1 is provided in a state in which the pair of retainers 70 are attached to the retainer first attachment holes 28 and the retainer second attachment holes 59. However, the space S1 need not be provided in the above-described attached state as long as the object of the present disclosure is not impaired.
(10) In the above embodiment, the cross section of the intermediate portion 21B of each of the male terminals 21 is formed in a substantially octagonal shape. However, the intermediate portion 21B may have any cross-sectional shape as long as the object of the present disclosure is not impaired.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector capable of being fitted to a counterpart connector in a first direction, comprising:
a first connector housing;
a second connector housing capable of accommodating the first connector housing; and
a retainer configured to be attached to extend in the first connector housing and the second connector housing, wherein
the retainer is configured to be attachable to the first connector housing and the second connector housing from a second direction that is orthogonal to the first direction in an accommodated state in which the first connector housing is accommodated in the second connector housing, and the retainer holds the first connector housing in the accommodated state.

2. The connector according to claim 1, wherein
the retainer is disposed so as to penetrate the second connector housing in the second direction in the accommodated state.

3. The connector according to claim 1, wherein
the retainer includes a lock portion configured to be locked to the first connector housing in the second direction in the accommodated state, thereby preventing dislodgement of the retainer.

4. The connector according to claim 3, wherein
the retainer includes a rotation prevention portion configured to prevent rotation of the lock portion in the accommodated state.
